(19) United States
(12) Patent Application Publication
(10) Pub. No.: US 2021/0150028 A1
(43) Pub. Date: May 20, 2021

(54) METHOD OF DEFENDING AGAINST MEMORY SHARING-BASED SIDE-CHANNEL ATTACKS BY EMBEDDING RANDOM VALUE IN BINARIES

(71) Applicant: Kwangwoon University Industry-Academic Collaboration Foundation, Seoul (KR)

(72) Inventors: Taehun KIM, Uiwang (KR); Youngjoo SHIN, Uijeongbu (KR)

(73) Assignee: Kwangwoon University Industry-Academic Collaboration Foundation, Seoul (KR)

(21) Appl. No.: 16/903,465

(22) Filed: Jun. 17, 2020

(30) Foreign Application Priority Data
Nov. 15, 2019 (KR) 10-2019-0146371

(51) Int. Cl. G06F 21/55; G06F 21/56; G06F 21/78; G06F 12/0879; G06F 8/658; G06F 7/58

(52) U.S. Cl. CPC G06F 21/556; G06F 21/562; G06F 7/588; G06F 12/0879; G06F 8/658; G06F 21/78

(57) ABSTRACT

A method of defending against memory sharing-based side-channel attacks comprises the steps of: acquiring a binary code of an original program; disassembling the binary code; finding an offset from a disassembled code; embedding a detour random value code including a detour instruction and a random value of a fixed or variable length at a location of a found offset; and outputting a rewritten program generated by embedding the detour random value code. Therefore, according to the present invention, it is possible to defend against the memory sharing-based side-channel attacks even with low overhead, and solve the problem of entropy shortage of the existing protection techniques such as KASLR, ASLR and the like.

### CROSS-REFERENCE TO RELATED APPLICATION

This application claims priority to Korean Patent Application No. 10-2019-0146371, filed on Nov. 15, 2019, which is incorporated by reference herein in its entirety.

### BACKGROUND OF THE INVENTION

### Field of the Invention

The present invention relates to a method of defending against side-channel attacks, and more particularly, to a method of defending against memory sharing-based side-channel attacks through binary rewriting of embedding a random value in a binary code. This work was supported by Institute of Information & communications Technology Planning & Evaluation (IITP) grant funded by the Korea government (MSIT)(No. 2019-0-00533, Research on CPU vulnerability detection and validation).

### Background of the Related Art

For 30 years after 32-bit computers are distributed, various memory protection techniques such as Kernel Address Space Layout Randomization (KASLR), ASLR, and Data Execution Prevention (DEP) have emerged to defend against vulnerability attacks such as Buffer Overflow (BOF), Return Oriented Programming (ROP) and the like or their variant vulnerability attacks. However, with continuous performance enhancement of computers, the defense techniques such as KASLR and ASLR are experiencing entropy shortage problem, and as the problem of side-channel attacks have emerged recently, a new defense method is required.

Particularly, FLUSH+RELOAD attacks are representative among the memory sharing-based side-channel attacks. For example, in a cloud environment such as Infrastructure as a Service (IaaS), a service provider activates the memory deduplication function of a hypervisor for efficiency of resources. Through the memory deduplication, the same pages of an attacker and a victim are shared, and the attacker may induce memory sharing by loading a page that the victim is expected to have on the memory through the mmap( ) function. FLUSH+RELOAD is a cache side-channel attack that can identify a specific activity by sharing cache lines on the basis of the memory sharing.

One of the methods of defending against the memory sharing-based side-channel attacks such as FLUSH+RELOAD or the like is to avoid using the memory deduplication function. In this case, the vulnerability attack problem can be solved as memory sharing does not occur. However, since the overhead remarkably increases, it is inadequate in an aspect as a defense method.

Another conventional technique is a static binary rewriting technique. For example, static binary rewriting is a method of transforming a gadget, which is a target of attacks such as ROP, BOF and the like, to enhance software security. The static binary rewriting technique generally uses a method of changing control flow using an instrumentation code by replacing a specific instruction with a trampoline instruction of the same length through a disassembly process or directly embedding an instrumentation instruction. Therefore, the static binary rewriting technique can be easily used in a system using a fixed-length instruction set. However, computers using variable-length instruction sets such as Intel x86 or x64, or AMD 32-bit or 64-bit, which are used in most computer systems, have difficulties in embedding trampoline instructions. It is since that when an original instruction to be replaced is variable-length, the length of one instruction unit and usage of a value vary depending on the context, so that it is difficult to replace the instruction without loss of original operation, and since the memory address and registers that the trampoline instruction may use should be estimated only by code analysis, it is difficult to guarantee accuracy as the instructions and control flow of the binary code are getting more diversified and complicated. In addition, for this reason, there has not been an example of using the static binary rewriting technique as a technique for defending against side-channel attacks in a virtualization environment of a server.

Since the memory sharing-based side-channel attacks have emerged in recent years and researches on the defense have begun not long before, a defensive measure capable of selectively defending against the memory sharing-based side-channel attacks for a specific program is urgently required.

### SUMMARY OF THE INVENTION

Therefore, the present invention has been made in view of the above problems, and it is an object of the present invention to provide a method of defending against memory sharing-based side-channel attacks, which can defend against the memory sharing-based side-channel attacks even with low overhead through a detour random value code (JMP+RAND) embedding technique.

In addition, another object of the present invention to provide a method of defending against memory sharing-based side-channel attacks, which can provide binary code rewriting in an easy way, although the binary code rewriting itself is difficult since generation of a trampoline instruction itself is very difficult in an existing static binary code rewriting technique.

In addition, still another object of the present invention to provide a method of defending against memory sharing-based side-channel attacks, which can solve the entropy shortage problem, although the entropy shortage problem occurs together with continuous performance enhancement of computers in various existing memory protection techniques such as Kernel Address Space Layout Randomization (KASLR), ASLR, and Data Execution Prevention (DEP).

The problems of the present invention are not limited to the problems mentioned above, and unmentioned other problems may be clearly understood by those skilled in the art from the following descriptions.

Therefore, to accomplish the above objects, a method of defending against memory sharing-based side-channel attacks according to an embodiment of the present invention may include the steps of: acquiring a binary code of an original program; disassembling the binary code; finding an offset from a disassembled code; embedding a detour random value code including a detour instruction (jmp) and a random value of a fixed or variable length at a location of a found offset; and outputting a rewritten program generated by embedding the detour random value code.

In this case, the random value of a fixed or variable length may be between 5 and 8 bytes.

In addition, the step of embedding a detour random value code may include the step of embedding the detour random value code in all pages.

In addition, the step of finding an offset may include the step of specifying the offset between two predetermined instructions of the disassembled code.

At this point, the method of defending against memory sharing-based side-channel attacks may further include the step of relocating the instruction and recovering symbol information.

In addition, the step of finding an offset may include the step of finding instructions to be patched, which have a length the same as a length of the detour instruction and the random value of a fixed or variable length.

At this point, the method of defending against memory sharing-based side-channel attacks may further include the step of copying the instructions to be patched in a new section.

In addition, the step of embedding a detour random value code may include the step of patching the instructions to be patched with the detour instruction and the random value of a fixed or variable length.

In addition, the instructions to be patched may include only instructions unrelated to linking.

Meanwhile, a computer-readable recording medium recording a program according to an embodiment of the present invention may be implemented to execute the methods described above.

Meanwhile, a binary rewriter according to an embodiment of the present invention may include: a disassembler for disassembling a binary code of an acquired original program; an offset finder for finding an offset from a disassembled code; and a code embedding module for embedding a detour random value code including a detour instruction and a random value of a fixed or variable length at a location of a found offset, and outputting a rewritten program generated by embedding the detour random value code.

In this case, the random value of a fixed or variable length may be between 5 and 8 bytes.

In addition, the detour random value code may be embedded in all pages.

In addition, the code embedding module may include an inject-based embedding module, and the offset finder may specify the offset between two predetermined instructions of the disassembled code.

In addition, the inject-based embedding module may relocate codes coming after the offset and recover symbol information after embedding the detour random value code.

In addition, the code embedding module may include a patch-based embedding module, and the offset finder may find instructions to be patched, which have a length the same as a length of the detour instruction and the random value of a fixed or variable length.

At this point, the patch-based embedding module may copy the instructions to be patched in a new section.

In addition, the patch-based embedding module may patch the instructions to be patched with the detour instruction and the random value of a fixed or variable length.

In addition, the instructions to be patched may include only instructions unrelated to linking.

### BRIEF DESCRIPTION OF THE DRAWINGS

FIG. 1 is a block diagram showing a system for performing a method of defending against memory sharing-based side-channel attacks according to an embodiment of the present invention.

FIG. 2 is a block diagram showing the configuration of a side-channel attack defense module according to an embodiment of the present invention.

FIG. 3 is a flowchart illustrating each step of a method of defending against memory sharing-based side-channel attacks according to an embodiment of the present invention.

FIG. 4 is a view showing assembly example codes of an original program and a rewritten program converted by an inject-based embedding module according to an embodiment of the present invention.

FIG. 5 is a view showing assembly example codes of an original program and a rewritten program converted by a patch-based embedding module according to an embodiment of the present invention.

FIG. 6 is a flowchart illustrating a detour random value embedding method by a patch-based embedding module according to an embodiment of the present invention.

FIG. 7 is a view comparing the pages generated by an existing protection technique and the pages generated by a protection technique according to the present invention.

FIG. 8 is a view showing a binary rewriter according to another embodiment of the present invention.

FIG. 9 is a graph showing performance evaluation of a detour random value embedding technique according to an embodiment of the present invention.

DESCRIPTION OF SYMBOLS

| | |
|---|---|
| 100: Server | 110: Shared resource |
| 120: Hypervisor | 130: Allocated resource |
| 140: Plurality of terminals | 200: Binary rewriter |
| 210: Disassembler | 220: Offset finder |
| 230: Code embedding module | 350: Rewritten program |
| 235: Inject-based embedding module | |
| 237: Patch-based embedding module | |
| 240: Plurality of pages | |
| 300: Original program | |
| 310: Detour random value code | |

### DETAILED DESCRIPTION OF THE PREFERRED EMBODIMENT

Advantages and features of the present invention and methods for achieving the same will be more clearly understood from the embodiments described below with reference to the accompanying drawings. However, the present invention is not limited to the following embodiments but may be implemented in various forms. The embodiments are provided merely to complete disclosure of the present invention and to fully provide a person having ordinary skill in the field of the art to which the present invention belongs with the category of the present invention. The present invention is defined only by the category of the claims.

In addition, since the shapes, sizes, ratios, angles, numbers and the like disclosed in the drawings for describing the embodiments of the present invention are exemplary, the present invention is not limited to the illustrated matters. In addition, in describing the present invention, when it is determined that detailed descriptions of related known technologies may unnecessarily obscure the gist of the present invention, detailed descriptions thereof will be omitted. When ‘include’, ‘have’, ‘comprise’ and the like mentioned in this specification are used, other parts may be added unless ‘only ˜’ is used. When a component is expressed as a singular number, it includes a case including a plural number unless otherwise specified.

In addition, in analyzing the components, it is interpreted as including an error range although there is no explicit description.

Each of the features of the various embodiments of the present invention may be partially or entirely coupled or combined with each other, and technically diverse interconnection and driving are possible as those skilled in the art may fully understand, and each of the embodiments may be independently implemented with respect to each other or may be implemented together in an associative relationship.

Cloud computing provides a multi-tenant infrastructure to users and service providers through the Internet for virtualization of computing resources. In addition, cloud service providing companies (e.g. Amazon AWS, Microsoft Azure, VMWare ESXi, etc.) have attracted many users and companies with resource efficiency and convenience. In this case, since the infrastructure-as-a-service (IaaS) has several virtual machines (VMs) over a single physical host at the same time, a lot of redundant memory and resource overheads occur.

Accordingly, cloud service providers have improved resource efficiency by about four times by supporting a memory deduplication function to solve this problem. However, this feature has become a source of memory sharing-based side-channel attacks and has compromised cloud security. As a result, almost all cloud computing providers have basically deactivated the memory deduplication function despite serious resource inefficiency.

A simple method of maintaining cloud security from the memory sharing-based side-channel attacks even when memory deduplication is used for resource efficiency is that a programmer embeds a predetermined value in each page at the source code level. However, this method is inefficient and infeasible as it burdens the programmer with additional workload and security knowledge. In addition, studies related to mitigation against these attacks have not considered memory management of cloud computing at all recently and only focused on the defense mechanism itself.

Therefore, it needs to provide a new mitigation that guarantees more stable and efficient cloud computing, as well as defensing the memory sharing-based side-channel attacks. This patent proposes a detour random value code embedding method (JMP+RAND method) as a new mitigation method. The detour random value code embedding method may be said to be a new design which is stable while reducing the memory sharing-based side-channel attacks by embedding a predetermined value in a binary code. The detour random value code embedding method may be used together with the memory deduplication function supported by the hypervisor by applying static binary instrumentation to specific security-sensitive applications.

In addition, the detour random value code embedding method may solve all the problems that occur when a predetermined value is embedded in a binary code and quantitatively evaluate complexity of an attack time. This patent implements the proof-of-concept of the detour random value code embedding method and describes it in detail. In addition, in this patent, it can be confirmed that the security-sensitive applications can be effectively protected from the memory sharing-based side-channel attacks through the detour random value code embedding method although memory deduplication is activated.

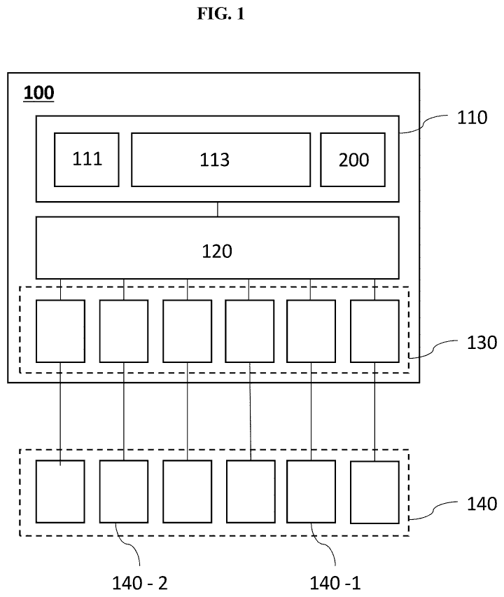

Hereinafter, an environment of a system 100 (server) in which a method of defending against memory sharing-based side-channel attacks according to an embodiment of the present invention is performed will be described in detail with reference to FIG. 1.

According to FIG. 1, a system 100 in which a method of defending against memory sharing-based side-channel attacks according to an embodiment of the present invention is performed is a personal PC or a cloud server using a virtualization function, and may include a shared resource 110, a hypervisor 120, and an allocated resource 130. In this case, the shared resource 110 may include a processor 111 of the server, a shared memory 113, and a binary rewriter 200 that is a characteristic module of the present invention. The binary rewriter 200 may be a software program, a software module, or a combination of the software/hardware modules, which can be executed on the server.

The allocated resource 130 is a resource allocated to each of a plurality of terminals 140, and may be, for example, an operating system that can be seen in each of the plurality of terminals 140 and an interface connected to each of the plurality of terminals 140.

The plurality of terminals 140 is connected to each allocated resource 130, and a user may be provided with, for example, a cloud virtualization service executed in the system 100 through the plurality of terminals 140.

In this case, the hypervisor 120 may manage execution of requests inputted from the plurality of terminals 140 through each allocated resource 130 through the shared resource 110 or through each allocated resource 130. In this case, the hypervisor 120 may perform a memory sharing (or memory deduplication) function to maximize efficiency of resource allocation. As described above, the hypervisor 120 scans the memory by the unit of page and merges the same pages into a single shared page when there are same pages.

Memory sharing of the hypervisor 120 is a technique of sharing memory between processes. Through the memory sharing, communication between processes is possible, and resource waste of duplicate memory can be reduced. The memory sharing method includes content-aware sharing and content-based sharing. The content-aware sharing is a method of sharing pages having the same content as shared libraries when processes perform several functions, and it is performed by the operating system.

The content-based sharing is referred to as memory deduplication and performed by the hypervisor. The hypervisor scans the memory by the unit of page, and when there are same pages, the hypervisor merges the same pages into a single shared page. The merged page has only read-only permission since a security problem may occur if anyone can modify the shared page. Therefore, when a process accesses a shared page with a write permission, a copy-on-write (COW) mechanism is applied together with a page fault. However, although it is described in this specification mainly focusing on the defense of side-channel attacks of the content-based sharing of the hypervisor for simplicity of description, the present invention is not limited thereto, and it is noted that the present invention may be also applied to the content-aware sharing.

Meanwhile, among the plurality of terminals 140, there may be an attacker terminal 140-1 trying to attack a specific terminal and a victim terminal 140-2 attacked by the attacker terminal. At this point, the hypervisor 120 allows the same pages of the attacker terminal 140-1 and the victim terminal 140-2 to be shared through memory deduplication.

In this case, the attacker terminal 140-1 may induce memory sharing by loading a page that the victim is expected to have on the memory through the mmap( ) function. FLUSH+RELOAD is a representative cache side-channel attack that can identify a specific activity by sharing cache lines based on the memory sharing. Most Intel architectures independently have L1 and L2 caches for each core and share L3 cache. Accordingly, the attacker terminal 140-1 may confirm use of the cache lines of the victim terminal 140-2 that uses the memory shared page by using the cache's inclusive policy and a clflush instruction for emptying the cache lines. At this point, the FLUSH+RELOAD attack is configured of three stages. FLUSH: The attacker terminal 140-1 empties the L3 cache line to be observed through the clflush instruction. According to the cache's inclusive policy, the cache lines of L1 and L2 associated with corresponding cache lines are also emptied. WAIT: Wait until the victim terminal 140-2 accesses a corresponding cache line. RELOAD: The attacker terminal 140-1 accesses the cache line again and knows that the victim terminal 140-2 accesses when the memory load speed is fast, the victim terminal 140-2 does not access when the memory load speed is slow.

In this environment, the binary rewriter 200 according to an embodiment of the present invention embeds a random value of 4 to 8 bytes by the unit of page (4 KB) through a binary rewriting technique of a detour random value code embedding method to compensate for the entropy shortage problem of the existing memory protection techniques (ASLR, KASLR) and prepare for defense against the memory sharing-based side-channel attacks. In addition, although the existing static binary rewriting technique is difficult to be utilized since it is very difficult to embed a trampoline instruction suitable for a specific program, the binary rewriting technique of the detour random value code embedding method according to the present invention also overcomes the difficulties of the static binary rewriting technique by simply utilizing a code configured of a detour instruction and a random value.

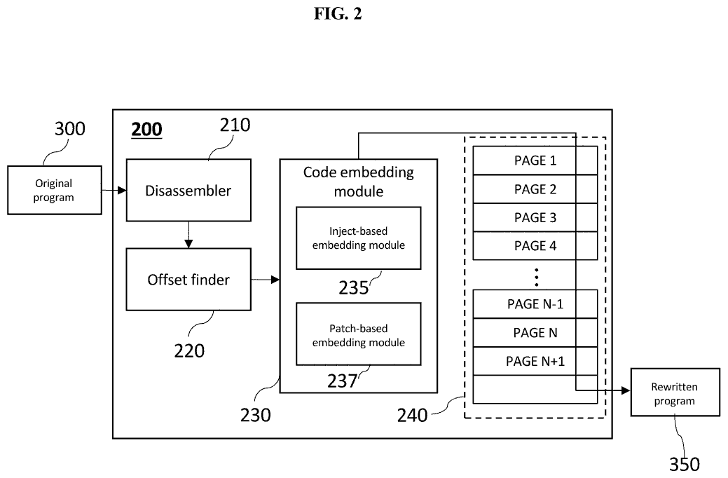

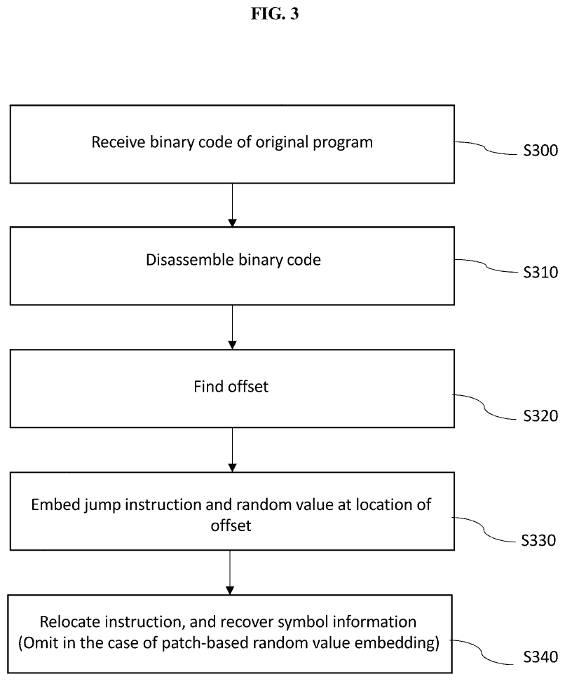

Hereinafter, a method of defending against memory sharing-based side-channel attacks according to an embodiment of the present invention will be described in detail with reference to FIGS. 2 and 3. FIG. 2 is a block diagram showing the configuration of a side-channel attack defense module according to an embodiment of the present invention. FIG. 3 is a flowchart illustrating each step of a method of defending against memory sharing-based side-channel attacks according to an embodiment of the present invention.

Referring to FIG. 2, the binary rewriter 200 according to an embodiment of the present invention includes a disassembler 210, an offset finder 220, and a code embedding module 230, and is executed using an original program 300 desired to be defended against a memory sharing-based side-channel attack as a parameter. At this point, a result of embedding a code is stored by the unit of page 240 (4 KB), and finally, a rewritten program execution file 350 is outputted. At this point, the process of embedding a binary random value into the program is as shown in FIG. 3.

First, the binary rewriter 200 is executed using the original program 300 desired to be defended against a memory sharing-based side-channel attack as a parameter, and at this point, the binary rewriter 200 acquires the binary code of the original program by receiving an input of the binary code (step S300). At this point, since the instruction may be broken or specific information may be damaged if the random value is embedded in any location of the binary code, the random value needs to be embedded after confirming semantics at the instruction level, in order to embed the random value while maintaining the semantics of the original program 300.

Accordingly, the acquired binary code of the program is disassembled through the disassembler 210 (step S310). For example, the disassembler 210 may be an objdump 102 tool supported by Linux. The disassembled code may be, for example, an assembly language code of a low-level programming language.

Meanwhile, the offset finder 220 of the binary rewriter 200 finds an offset capable of embedding a random value by the unit of instruction from the disassembled original program 300 (step S320).

However, in the code embedding module 230, the offset capable of embedding a random value varies according to whether the random value is embedded based on injecting or patching. Referring to FIG. 2, the code embedding module 230 may include an inject-based embedding module 235 and a patch-based embedding module 237. In this case, the code embedding module 230 determines an embedding method according to selection or setting of a user, and the offset finder 220 finds an offset according to the determined embedding method.

On the other hand, when an offset for embedding a random value is found, a detour instruction and a random value are embedded in at least some pages 240 at the binary level according to the determined embedding method in the detour random value code embedding method (step S330). In this specification, the detour random value code embedding method (JMP+RAND method) means a method of embedding a detour random value code including a code that can detour the random value part when the program is executed, e.g., a detour instruction such as a JMP instruction, and a predetermined random value part. In this case, since the hypervisor 120 determines whether or not to share the memory by the unit of page, it is preferable to embed a random value in every page unit (4 KB) in order to defend against the memory sharing-based side-channel attacks.

In addition, in the case of the inject-based embedding module 235, since the offsets of all instructions are changed after embedding a detour random value code, instruction relocation and symbol information recovery are needed (step S340). However, since the patch-based embedding module 237 does not need instruction relocation and symbol information recovery, the instruction relocation and symbol information recovery step (S340) is an optional step.

Finally, the binary rewriter 200 outputs and stores the rewritten program 350, and thereafter, the rewritten program 350 is executed when execution of the corresponding original program 300 is requested.

In the case of a side-channel attack, the attacker terminal 140-1 may induce memory sharing by loading a page that the victim terminal 140-2 is expected to have on the memory through the mmap( ) function, and specific activities of the victim terminal 140-2 may be monitored by sharing the cache lines on the basis of the memory sharing. In addition, the attacker terminal 140-1 may steal sensitive information of the victim terminal 140-2, such as an authentication key, important personal information and the like, by monitoring the specific activities.

However, the binary rewriter 200 which embeds a detour random value code according to the present invention may remarkably enhance security by making it practically impossible for the attacker terminal 140-1 to predict a page of the victim terminal 140-2.

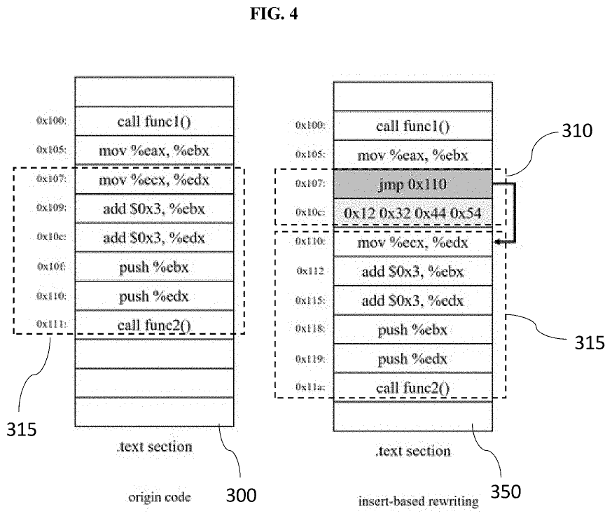

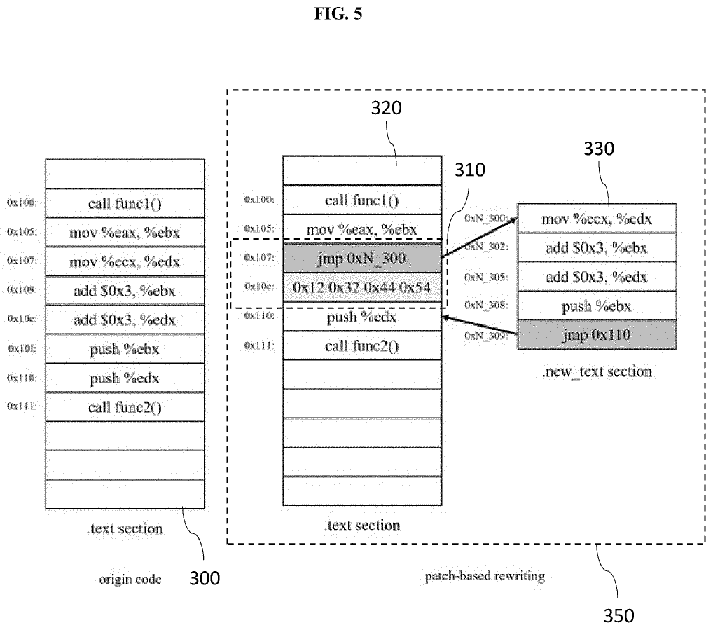

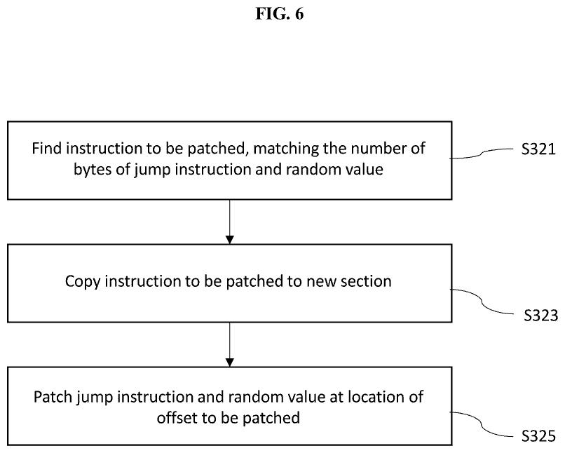

Hereinafter, the detour random value embedding method will be described in more detail with reference to FIGS. 4 to 6. FIG. 4 is a view showing assembly example codes of an original program 300 and a rewritten program 350 converted by an inject-based embedding module 235 according to an embodiment of the present invention. FIG. 5 is a view showing assembly example codes of an original program 300 and a rewritten program 350 converted by a patch-based embedding module 237 according to an embodiment of the present invention. FIG. 6 is a flowchart illustrating a detour random value embedding method by a patch-based embedding module 237 according to an embodiment of the present invention.

Referring to FIG. 4, the characteristic of the inject-based embedding module 235 is that a detour random value code 310 may be embedded anywhere between instructions. The offset finder 220 may specify a point between two predetermined instructions as an offset position. In FIG. 4, address 0x107 is designated as an offset position, and a detour random value code 310 is embedded at the address of 0x107, which is a specified offset position. In this case, the detour random value code 310 includes the detour instruction “jmp 0x110” and a random value (0x12 0x32 0x44 0x54) randomly generated in a predetermined length. The existing code 315 is relocated at the address of 0x110 after the detour instruction.

That is, the inject-based embedding module 235 according to an embodiment of the present invention may embed a random value into a program without meaning by embedding the random value after the detour instruction (JMP instruction). In addition, since the offsets of all instructions coming after the detour random value codes 310 (JMP+RAND) are changed, relocation of the existing code 315 or recovery of symbol information may be performed together with random value embedding.

The inject-based embedding module 235 uses a method of embedding a detour random value code (jmp+rand) between instructions in the .text section using the disassembler 210. The difference may be seen more clearly by comparing the original program 300 and the rewritten program 350 of FIG. 4. Since the detour random value code (jmp+rand) is added between two predetermined instructions, the offset of relocation and symbol information effected by an address after the embedded detour random value code (jmp+rand). Therefore, whFedeen the inject-based random value embedding technique is used, relocation and symbol information should be corrected in accordance with the changed offset before executing the program. For example, the jmp instruction has a length of 5 bytes, and for example, since a random value of 4 to 8 bytes is embedded, a size increase of 9 to 13 bytes and a branch instruction are added in every 4 KB pages.

On the other hand, referring to FIGS. 5 and 6, the patch-based embedding module 237 finds an instruction to be patched, matching the number of bytes of the detour random value code 310, copies the instruction to be patched into a new section 330, and then replaces the instruction to be patched with the detour random value code 310.

When the patch-based embedding module 237 is used, first, the offset finder 220 finds at least one instruction to be patched considering the length of the detour instruction and the random value (step S321). That is, the offset finder 220 finds instructions to be patched, having the same number of bytes as that of the length of the generated random value and the detour instruction. At this point, the instructions to be patched may be instructions not related to linking. For example, in FIG. 5, the instruction call funcl( ) is a part that needs linking when a link is made by performing a function call, and since the mov % ecx, % edx instruction, the add $0x3, % edx instruction, and the like are instructions for adding or moving through simple reference to a register and are not related to linking, they can be instructions to be patched, which can be patched.

In addition, on the other hand, in the original program 300 of FIG. 5, the instructions from address 0x107 to address 0x110 are copied into the new section 330. That is, instructions to be patched are copied into the new section 330 (step S323). At this point, after the instructions are copied into the new section 330, a return instruction (jmp 0x110) for jumping to an address (0x110) of the next execution code is added.

Finally, the detour random value code 310 is patched to the location of the instructions to be patched. That is, the detour random value code 310 is overwritten in substitution for the instructions to be patched (step S325). Accordingly, when the instructions to be patched are found, the patch-based embedding module 237 rewrites the original code in accordance with the number of bytes of the instructions so that the offset of the instructions after the instructions to be patched may not change. Accordingly, although a random value may not be embedded between arbitrary instructions like the inject-based embedding module 235, there is an advantage in that relocation and symbol information recovery are not required.

Meanwhile, although the inject-based random value embedding method should recover information on relocation and symbols, a module that embeds a random value without regard to the information recovery is the patch-based embedding module 237. Instructions to be patched in each page are found in a .text section, such as the .text section 320 of the rewritten program 350 of FIG. 5. As the instructions to be patched are not related to the information such as relocation and symbols, an instruction statically completing a binary without regard to linking becomes a candidate. It is formed in a method of finding instructions of 9 to 13 bytes according to the size of a random value to be embedded, patching the instructions with the detour random value code 310 (jmp+rand), copying the selected instructions at the end of the .text section or in a new section, and finally returning to the original code flow through a return instruction (jmp instruction). Comparing the original program 300 and the rewritten program 350, it can be confirmed that reference to the address of the instructions other than the patched instructions is the same (the part after 0x110). Although two jmp instructions are added in each page in the embodiment of the present invention, it is expected that there is almost no overhead generated through the jmp instructions in modern architectures.

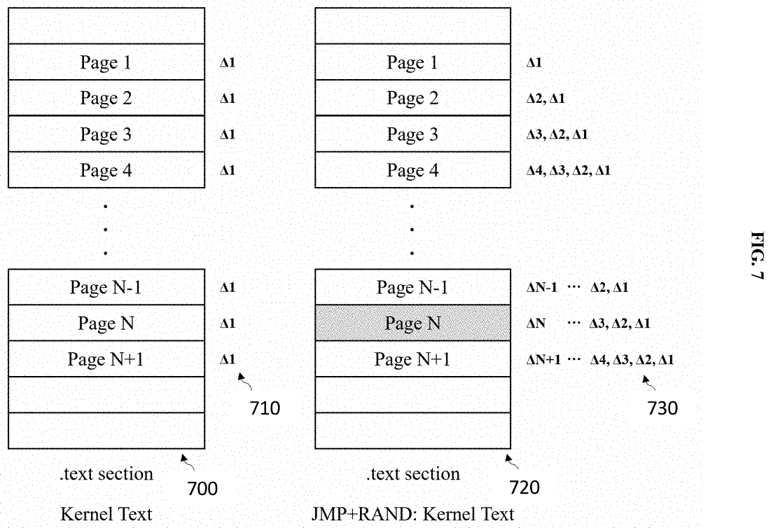

Meanwhile, the inject-based embedding module 235 and the patch-based embedding module 237 variably generate a random value to be embedded in a size of, for example, 4 to 8 bytes. This complements the disadvantages of existing protection techniques, e.g., KASLR and ALSR, and this will be described in detail with reference to FIG. 7. FIG. 7 is a view comparing the pages 700 generated by an existing protection technique and the pages 720 generated by a protection technique according to the present invention.

As is seen in FIG. 7, since all pages are added by the same delta value 710 in the existing protection technique 700, information on all pages may be exposed when only the delta value 301 of a page can be acquired. However, in the detour random value code embedding method 720 which embeds the detour random value code 310 of the present invention, the delta value 730 that should be be found to attack a specific page increases since the size of the random value embedded in each page varies. As shown in the detour random value code embedding method 720, the delta value 730 of each of the 1st to N−1-th pages should be found to attack the contents of the N-th page.

That is, the binary rewriter 200 according to an embodiment of the present invention embeds a random value having a variable length (5 to 8 bytes) in each 4 KB page in the .text section of the program to complement KASLR and ALSR, which are existing memory protection techniques, and defend against side-channel attacks at the same time. Since the number of bytes to be embedded in each page is not constant, the N-th page of the .text section has a dependency on the N−1 pages. At this point, although a random value having a fixed length (5 to 8 bytes) is embedded, sufficient security can be secured, and in case of having a variable length, additional enhancement of security is possible.

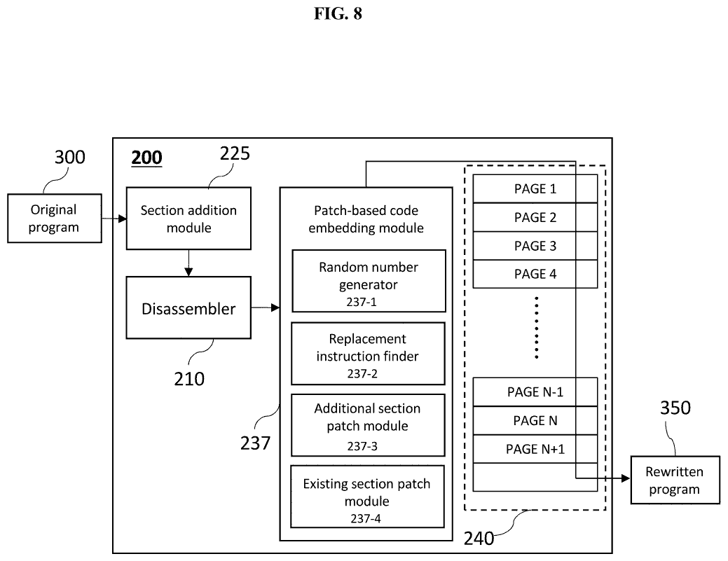

Hereinafter, a binary rewriter 200 according to another embodiment of the present invention will be described with reference to FIG. 8. The binary rewriter 200 according to another embodiment of the present invention basically operates in a patch-based manner.

Referring to FIG. 8, the binary rewriter 200 according to an embodiment of the present invention includes a disassembler 210, a section addition module 225, and a patch-based code embedding module 237, and is executed using the original program 300 desired to be defended against a memory sharing-based side-channel attack as a parameter. Since a binary rewriter 200 according to still another embodiment of the present invention is basically the same as the patch-based code embedding module of FIGS. 2 and 3, descriptions of the redundant and unnecessary parts are omitted.

In this case, the binary rewriter 200 first receives the binary code of the original program 300 and then additionally secures a region to which a new section is added. That is, the .new_text section of FIG. 5 is added first. Then, the acquired binary code is disassembled through the disassembler 210.

On the other hand, the patch-based code embedding module according to the present embodiment may include a random number generator 237-1, a replacement instruction finder 237-2, an additional section patch module 237-3, and an existing section patch module 237-4.

At this point, the random number generator 237 generates a random value to be patched. It is desirable to embed a random value of 5 to 8 bytes, and in this case, since an attacker needs a minimum of about 10⁹ minutes and a maximum of 10¹⁹ minutes to attack a general server or a cloud computing environment and may increase the size of the text section of the binary code by 0.325%, it can be defended sufficiently. On the other hand, when a too small random value of 4 bytes or less is generated, it is difficult to sufficiently defend, and embedding a too large random value of 8 bytes or more may be an overhead of memory resources.

When a random value is generated, the replacement instruction finder 237-2 finds an instruction to be patched, matching the number of bytes of the generated detour random value code 310.

Thereafter, the additional section patch module 237-3 patches the new section 330 added with the instruction to be patched, which is found by the replacement instruction finder 237-2. Then, the existing section patch module 237-4 patches the part of the instruction to be patched, which is found by the replacement instruction finder 237, with a JMP code and the random value.

Finally, the binary rewriter 200 outputs and stores the rewritten program 350, and when execution of the corresponding original program 300 is requested thereafter, the rewritten program 350 is executed.

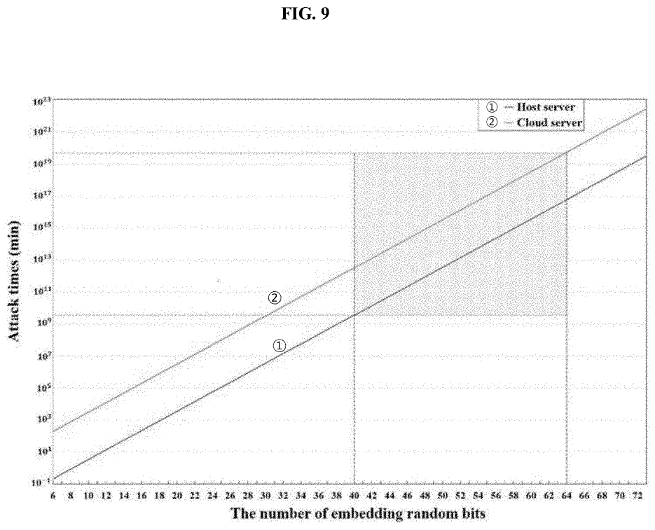

Hereinafter, performance evaluation and expected effects about whether the JMP+RAND technique is suitable as a technique of defending against a memory sharing-based side-channel attack will be described with reference to FIG. 9. For the sake the performance evaluation, a time of attacking a program according to the size of the random value embedded in each page is expressed as an equation and a graph. In addition, the time of attacking a program that has page dependency is evaluated using the probability distribution based on changes in the size of the random value embedded in each page. In the performance evaluation of this patent, attack time complexity changed by the size of the embedded random value is described, rather than considering the time of embedding or patching instructions in the .text section.

The detour random value code embedding method is a defense technique that makes it difficult to share memory by embedding a random value in each page. An attacker cannot share memory with a victim because of the random value embedded in the binary code and should perform a brute force attack to attempt a memory sharing-based side-channel attack. We have performed the following experiment to calculate time complexity of the memory sharing-based side-channel attack, which varies with the size of the embedded random value. On the basis of the Gruss et al.'s PoC code and Kim et al. [8], it is found through the experiment that it consumes about 0.03 minutes to perform a cache side-channel attack (i.e., Flush+Reload) in an environment using Intel® Core™ i5-7400 3.00 GHz processor and 16 GB memory, and 3 minutes to perform a memory exposure attack in a cloud computing environment. (see “Flush+Flush: A Fast and Stealthy Cache Attack” in DIMVA 2016 (D. Gruss, C. Maurice, K. Wagner, and S. Mangard) and Breaking KASLR by using Memory Deduplication in Virtualized Environments, CISC-W'19 (Taehyun Kim, Taehun Kim, Youngjoo Shin) Meanwhile, it is confirmed through the experiment that it has the attack time complexity of FIG. 8 to attack a binary code to which the detour random value code embedding technique is applied.

FIG. 9 is a graph that can be acquired through Equation 1 shown below when it is assumed that the size of the embedded bits is N, and the time required to succeed a memory sharing-based side-channel attack is Tatk.

$${T}_{atk} = \{ \begin{matrix}{2}^{N \times 8} \times 0.03 ( m ) \\ {2}^{N \times 8} \times 3 ( m )\end{matrix} \qquad ( Equation 1 )$$

Since N is the size of bits to be embedded in the program, the size of the program increases as N increases. When it is assumed that S_{JMP+RAND} is the text section size of the program to which the detour random value code embedding technique is applied and S_{Origin} is the text section size of the original program to which the detour random value code embedding technique is not applied, S_{JMP+RAND} can be obtained using Equation (2).

$${S}_{JMP + RAND} = ( 1 + \frac{5 \times 8 + N}{4096 \times 8} \times 100 ) \times {S}_{Origin} \qquad ( Equation 2 )$$

Therefore, embedding a too large random value can be an overhead of memory resources. When a random value of 5 to 8 bytes is embedded, an attacker needs a minimum of about 10⁹ minutes and a maximum of 10¹⁹ minutes to attack a general server or a cloud computing environment, and the size of the text section of the binary code increases by 0.325%.

Hereinafter, the expected effect of the present invention implemented as described above will be described in detail. For example, conventional memory protection techniques such as the 9-bit kernel text of KASLR and the 19-bit stack of ASLR have a problem of low entropy. Low entropy is vulnerable to memory disclosure attacks and may also be vulnerable to memory sharing-based side-channel attacks. However, according to the present invention, it is possible to indirectly increase the entropy of at least 32 to 64 bits with a low overhead and may also defend memory sharing-based side-channels through a detour random value code (JMP+RAND) embedding technique. In addition, the existing KASLR and ASLR do not have dependency of each page. Previously, when an attacker wants to attack a specific N-th page through deduplication, the attacker only needs to prepare the corresponding page in accordance with the entropy. However, since the detour random value code (JMP+RAND) embedding technique does not fix an embedded random value, there are N−1 dependencies like the code 720 of FIG. 7 when the attacker wants to attack the N-th page. Accordingly, the entropy is expected to be substantially much larger than 32 to 64 bits. Particularly, when the memory deduplication technique and the present invention are applied together in a virtualization environment, security can be significantly enhanced in a program that requires security, together with high resource efficiency.

Meanwhile, the system according to the present invention may be implemented as a computer-readable code recorded in a computer-readable recording medium. The computer-readable recording medium includes all kinds of recording devices in which data that can be read by a computer system are stored. The computer-readable recording medium includes magnetic storage media (e.g., ROM, floppy disk, hard disk, etc.) and optical reading media (e.g., CD-ROM, DVD, etc.). In addition, the computer-readable recording medium may be distributed in computer systems connected through a network, and the computer-readable code may be stored and executed in a distributed manner.

Accordingly, according to the present invention, there is provided a method of defending against memory sharing-based side-channel attacks, which can defend against the memory sharing-based side-channel attacks even with low overhead through a detour random value code (JMP+RAND) embedding technique.

In addition, although binary code rewriting itself is difficult since generation of a trampoline instruction itself is very difficult in an existing static binary code rewriting technique, the present invention provides a method of defending against memory sharing-based side-channel attacks, which can provide binary code rewriting in an easy way.

In addition, although the entropy shortage problem occurs together with continuous performance enhancement of computers in various existing memory protection techniques such as Kernel Address Space Layout Randomization (KASLR), ASLR, and Data Execution Prevention (DEP), according to the present invention, there is provided a method of defending against memory sharing-based side-channel attacks, which can solve the entropy shortage problem.

Although the present invention has been described in more detail by way of examples, the present invention is not necessarily limited to these examples and may be variously modified without departing from the spirit of the present invention. Therefore, the embodiments disclosed in the present invention are not intended to limit the technical spirit of the present invention, but to explain, and the scope of the technical spirit of the present invention is not limited by these embodiments. The protection scope of the present invention should be interpreted by the claims below, and all technical spirits within the equivalent range should be interpreted as being included in the scope of the present invention.

### TEXT IN THE FIGURES

(FIG. 2)
210: Disassembler
220: Offset finder
230: Code embedding module
235: Inject-based embedding module
237: Patch-based embedding module
300: Original program
350: Rewritten program

(FIG. 3)
S300: Receive binary code of original program
S310: Disassemble binary code
S320: Find offset
S330: Embed jump instruction and random value at location of offset
S340: Relocate instruction, and recover symbol information (Omit in the case of patch-based random value embedding)

(FIG. 6)
S321: Find instruction to be patched, matching the number of bytes of jump instruction and random value
S323: Copy instruction to be patched to new section
S325: Patch jump instruction and random value at location of offset to be patched

(FIG. 8)
210: Disassembler
225: Section addition module
237: Patch-based code embedding module
237-1: Random number generator
237-2: Replacement instruction finder
237-3: Additional section patch module
237-4: Existing section patch module
300: Original program
350: Rewritten program

What is claimed is:

1. A method of defending against memory sharing-based side-channel attacks, the method comprising the steps of:
acquiring a binary code of an original program;
disassembling the binary code;
finding an offset from a disassembled code;
embedding a detour random value code including a detour instruction and a random value of a fixed or variable length at a location of a found offset; and
outputting a rewritten program generated by embedding the detour random value code.

2. The method according to claim 1, wherein the random value of a fixed or variable length is between 5 and 8 bytes.

3. The method according to claim 1, wherein the step of embedding a detour random value code includes the step of embedding the detour random value code in all pages.

4. The method according to claim 1, wherein the step of finding an offset includes the step of specifying the offset between two predetermined instructions of the disassembled code.

5. The method according to claim 4, further comprising the step of relocating the instruction and recovering symbol information.

6. The method according to claim 1, wherein the step of finding an offset includes the step of finding instructions to be patched, which have a length the same as a length of the detour instruction and the random value of a fixed or variable length.

7. The method according to claim 6, further comprising the step of copying the instructions to be patched in a new section.

8. The method according to claim 7, wherein the step of embedding a detour random value code includes the step of patching the instructions to be patched with the detour instruction and the random value of a fixed or variable length.

9. The method according to claim 6, wherein the instructions to be patched include only instructions unrelated to linking.

10. A computer-readable recording medium recording a program for executing the method according to claim 1.

11. A binary rewriter comprising:
a disassembler for disassembling a binary code of an acquired original program;
an offset finder for finding an offset from a disassembled code; and
a code embedding module for embedding a detour random value code including a detour instruction and a random value of a fixed or variable length at a location of a found offset, and outputting a rewritten program generated by embedding the detour random value code.

12. The rewriter according to claim 11, wherein the random value of a fixed or variable length is between 5 and 8 bytes.

13. The rewriter according to claim 11, wherein the detour random value code is embedded in all pages.

14. The rewriter according to claim 11, wherein the code embedding module includes an inject-based embedding module, and the offset finder specifies the offset between two predetermined instructions of the disassembled code.

15. The rewriter according to claim 14, wherein the inject-based embedding module relocates codes coming after the offset and recovers symbol information after embedding the detour random value code.

16. The rewriter according to claim 11, wherein the code embedding module includes a patch-based embedding module, and the offset finder finds instructions to be patched, which have a length the same as a length of the detour instruction and the random value of a fixed or variable length.

17. The rewriter according to claim 16, wherein the patch-based embedding module copies the instructions to be patched in a new section.

18. The rewriter according to claim 17, wherein the patch-based embedding module patches the instructions to be patched with the detour instruction and the random value of a fixed or variable length.

19. The rewriter according to claim 16, wherein the instructions to be patched include only instructions unrelated to linking.
